(19) United States
(12) Patent Application Publication
(10) Pub. No.: US 2012/0002112 A1
(43) Pub. Date: Jan. 5, 2012

(54) TAIL THE MOTION METHOD OF GENERATING SIMULATED STROBE MOTION VIDEOS AND PICTURES USING IMAGE CLONING

(75) Inventors: Kuang-Man Huang, San Jose, CA (US); Mark Robertson, Cupertino, CA (US); Ming-Chang Liu, San Jose, CA (US)

(73) Assignee: SONY CORPORATION, Tokyo (JP)

(21) Appl. No.: 12/829,716

(22) Filed: Jul. 2, 2010

(51) Int. Cl. H04N 9/74

(52) U.S. Cl. 348/579; 348/E09.055

(57) ABSTRACT

The apparatus generates simulated strobe effects in the form of video or still image output in response to receipt of a video stream, and without the need of additional strobe hardware. Videos of a moving target object are categorized into one of multiple categories, from which a strobe generation process is selected. In one mode, the two categories comprise target objects with either small motion or large motions in relation to the frame size. Interoperation between image registration and cloning are utilized to produce simulated strobe motion videos or pictures. Motion segmentation is applied to the foreground object in each image frame, and a foreground mask is updated as each checkpoint is reached along the object trajectory, such as in response to time differences between checkpoints. Potential applications include special features for camcorders, digital cameras, or computer software.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to strobe motion video and picture generation, and more particularly to simulated strobe motion generation in response to the combination of image registration and cloning.

2. Description of Related Art

Strobe motion viewing allows motions to be more readily discerned over space and time, such as in viewing the movement of an athlete. In strobe motion viewing, the moving object is perceived as a series of images depicted along the object trajectory. These techniques are becoming widely used in sporting events, including the Olympics.

Early strobe motion viewing was facilitated by using electric strobe lights which emitted brief and rapid light flashes. More recently, advanced stroboscopic techniques are being introduced. Dartfish® provides a technique referred to as StroMotion™, which reveals the evolution of an athlete's movement, and which is based on stroboscoping, to analyze rapid movement so that a moving object is perceived as a series of static images along the object's trajectory. However, this method, and similar recently developed techniques, can be only applied when the target object is subject to relatively large motions.

Accordingly, a need exists for a system and method of simulating strobe motion whether the target object is subject to small or large motions. These needs and others are met within the present invention, which overcomes the deficiencies of previously developed strobe motion apparatus and methods.

### BRIEF SUMMARY OF THE INVENTION

A simulated strobe imaging apparatus and method are described which interoperably combine image registration and image cloning to produce strobe motion-like videos and pictures. An apparatus according to the invention, receives video input of a moving target object and produces strobe motion-like videos and pictures.

During processing, programming within the apparatus categorizes moving target objects within the video into multiple categories. Target objects within the different categories are handled in different ways according to the invention. One level of categorization depends on gross (large) movements. It should be appreciated that objects with sufficiently large movements require a moving camera field of view, to capture the movement. Objects subject to lesser motions, can be captured with a static camera (non-moving field of view) having a field of view which is adequate to span the whole range of the target object movement. These primary categories are then preferably sub-divided to enhance operation of the technique.

The invention combines image registration and cloning for the generation of strobe motion-like videos or pictures without requiring the use of a camera configured for performing strobe motion capture. The apparatus and method can be implemented within a variety of still and video imaging devices, including digital cameras, camcorders, and video processing software.

The invention is amenable to being embodied in a number of ways, including but not limited to the following descriptions.

One embodiment of the invention is an apparatus for generating simulated strobe effects, comprising: (a) a computer configured for receiving video having a plurality of frames; (b) a memory coupled to the computer; and (c) programming executable on the computer for, (c)(i) receiving a video input of a target object in motion within a received video sequence, (c)(ii) determining whether the camera is capturing target object motion within the received video sequence in response to a static positioning or in response to a non-static positioning, (c)(iii) selecting a strobe effect generation process, from multiple strobe effect generation processes, in response to determining the static positioning or the non-static positioning, and (c)(iv) generating a simulated strobe effect output in which one or more foreground elements are extracted from prior video frames and combined into a current frame in response to registering and cloning of images within the video input. The simulated strobe motion output is a still image or video which contains multiple foreground images of a target object, representing different time periods along a trajectory captured in the received video sequence, over a single background image. The apparatus is selected from the group of devices configured for processing received video sequences consisting of camcorders, digital cameras, video recorders, image processing applications, televisions, display systems, computer software, video/image editing software, and/or combinations thereof.

In at least one implementation, the generation of simulated strobe effect output is performed in response to: (a) applying motion segmentation to detect a foreground object in each image frame of the received video sequence; (b) selecting at least one checkpoint image based on time differences of each image frame within the received video sequence to attain a desired interval between checkpoint images; and (c) updating an overall foreground mask and pasting an overall foreground area on future images as each the checkpoint image is reached. In at least one implementation, a background model is generated for applying the motion segmentation if the relative motion of the target object is large in relation to the frame size. In at least one implementation, the apparatus is further configured for selecting between motion tracking for large motions or image differencing for small motion when determining a region of interest (ROI) within the received video sequence. In at least one implementation, the apparatus further is configured for determining image differences as a basis of segmenting the region of interest within the received video sequence.

In at least one implementation, the multiple strobe effect generation process comprises at least a first process and a second process. The first process is selected in response to detection of commencement of target object motion. In response to detecting a large motion, that is accumulated motion exceeding a threshold, then a switch is made from the first process to the second process. If no large motion is detected, then generation of simulated strobe effect output continues according to the first method for small motion.

In at least one implementation, still image simulated strobe effect output is generated in response to programming executable on the computer, comprising: (a) dividing an image area which overlaps between each pair of adjacent images in response to; (b) forcing a cutting line to pass through a middle point of centroids of an identified moving object in each pair of adjacent images using a cost function; and (c) increasing the cost function within the image area of the identified moving object to prevent cutting through the identified moving object.

One embodiment of the invention is an apparatus for generating simulated strobe effects, comprising: (a) a computer configured for receiving a video input having a plurality of frames; (b) a memory coupled to the computer; and (c) programming executable on the computer for, (c)(i) receiving the video input of a target object in motion within a received video sequence, (c)(ii) determining whether the received video sequence is capturing small or large target object motion, (c)(iii) generating or updating a background model in response to detection of large target object motion, (c)(iv) applying motion segmentation, (c)(v) selecting checkpoint images, and (c)(vi) generating a simulated strobe effect output (e.g., still images or video) in which one or more foreground elements are extracted from prior video frames and combined into a current frame in response to registering and cloning of images within the video input. The apparatus is selected from a group of devices configured for processing received video consisting of camcorders, digital cameras, video recorders, image processing applications, televisions, display systems, computer software, video/image editing software, and/or combinations thereof.

In at least one implementation, image differences are determined as a basis for segmenting a region of interest within the video sequence. In at least one implementation, the simulated strobe motion output contains multiple foreground images of the target object, representing different time periods along a trajectory captured in the received video sequence, over a single background image. In at least one implementation, the still image simulated strobe output is generated in response to programming executable on the computer, comprising: (a) dividing an overlapping area between each pair of adjacent images in response to; (b) forcing a cutting line to pass through a middle point of centroids of the target object, as represented in the adjacent images, using a cost function; and (c) increasing the cost function within the overlapping area, between the pair of adjacent images, to prevent cutting through representations of the target object in either of the pair of adjacent images.

One embodiment of the invention is a method of generating simulated strobe effects, comprising: (a) receiving video input of a target object in motion within a received video sequence; (b) determining whether the received video sequence depicts capturing target object motion within the received video sequence in response to a static positioning or in response to a non-static positioning; (c) selecting a strobe effect generation method, from multiple strobe effect generation methods, in response to determining the static positioning or the non-static positioning; and (d) generating a simulated strobe effect output (e.g., still image or video) in which one or more foreground elements are extracted from prior video frames and combined into a current frame in response to registering and cloning of images within the video input.

The present invention provides a number of beneficial elements which can be implemented either separately or in any desired combination without departing from the present teachings.

An element of the invention is the generation of strobe image output from a video input sequence, without the need of specialized strobe video hardware.

Another element of the invention is the ability to generate video output or still image output as desired.

Another element of the invention is the ability to switch between different strobe generation processes depending on the characteristics of the video input sequence, and in particular target object motion therein.

Another element of the invention is to determine whether the target object is subject to small or large motions, in relation to the frame, and to process strobe generations differently in each case.

Another element of the invention is the ability to generate strobe output in response to switching between strobe generation processes based on the current motion of the target object, such as starting with small object motion.

Another element of the invention is to create and update a background image model when the target object is subject to large motion within the frame.

A still further element of the invention is an apparatus and method which is applicable to camcorders, digital cameras, image processing applications, computer software, video/image editing software, and combinations thereof.

Further element of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flow diagram of motion video categorization performed according to an embodiment of the present invention.

FIG. 2A through 2C are difference images according to an element of the present invention, showing the extraction of a foreground mask.

FIG. 3A through 3C are difference images according to an element of the present invention, showing updating of the overall foreground mask.

FIG. 4A through 4B are images depicting an overall foreground mask and an output image frame shown according to an element of the present invention.

FIGS. 5A and 5B are images depicting foreground image cleaning according to an element of the present invention.

FIG. 6 is a graphical flow of image compositions according to an element of the present invention.

FIG. 7A through 7C are images depicting determination of a starting point according to an element of the present invention.

FIG. 8 is a pixel diagram depicting dividing the overlapping area in each pair of adjacent images to performing image cutting according to an element of the present invention.

FIG. 9 is a simulated strobe image according to an element of the present invention, showing a middle point cut line.

FIG. 10 is a simulated strobe image according to an element of the present invention, showing multiple frame stitching.

FIG. 11 is a block diagram of a simulated strobe imaging apparatus according to an embodiment of the present invention.

FIG. 12 is a flowchart of simulated strobe imaging in response to small motions according to an embodiment of the present invention.

FIG. 13 is a flowchart of simulated strobe imaging in response to large motions according to an embodiment of the present invention.

### DETAILED DESCRIPTION OF THE INVENTION

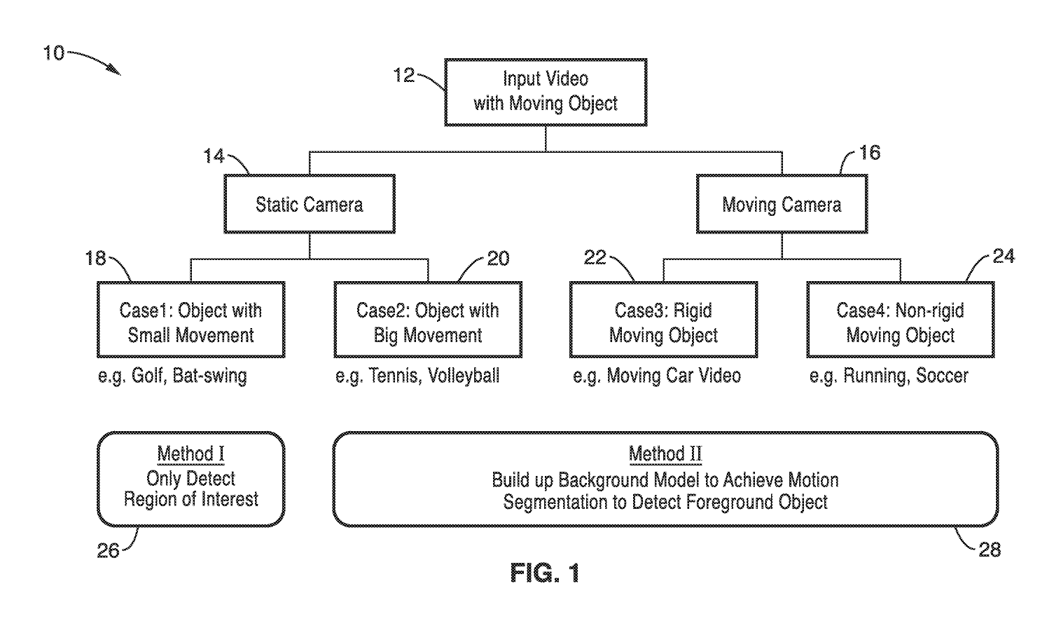

Referring more specifically to the drawings, for illustrative purposes the present invention is embodied in the apparatus generally shown in FIG. 1 through FIG. 13. It will be appreciated that the apparatus may vary as to configuration and as to details of the parts, and that the method may vary as to the specific steps and sequence, without departing from the basic concepts as disclosed herein. Furthermore, elements represented in one embodiment as taught herein are applicable without limitation to other embodiments taught herein, and combinations with those embodiments and what is known in the art.

1. Introduction to Tail the Motion Simulated Strobe Imaging.

The invention comprises a camera, or other video processing apparatus, which captures or receives moving object video as input and produces a form of simulated strobe motion videos and/or pictures (still images). The object motions of interest are categorized based on camera and object characteristics. Generating simulated strobe motion output provides the viewer an ability to follow an athlete's movement over space and time (Tail the Motion), with the moving object perceived as a series of images along its trajectory. Strobe effect output can be beneficial in a number of different applications, including sporting events, or in any situations in which it is desired to increase the visibility of step-wise motions.

It will be noted that when an object being filmed (e.g., target or subject) makes small movements within the frame (e.g., a putting stroke in golf) then the camera can remain stationary, however, in response to large motions relative to the frame, the camera needs to move (e.g., combination of panning, tilting, and/or translation) with the object in order to capture the movement. Conversely, a static camera may be utilized to capture video for a whole range of movement of target objects subject to small movements, which a static camera sufficient field of view to cover.

Previously, methods have been implemented for rendering strobe effects for only a single type of video segment. The present invention, however, can provide proper strobe effect output across a broad range of object movements and compositions, as it distinguishes different categories of motion and composition and adapts strobe processing accordingly by deciding which methods to use (motion tracking or image differencing) based on a brief analysis of the beginning of the input video. For example, the present invention generates a proper strobe output regardless of whether the video input received is subject to either large motion or small motion.

The inventive apparatus uses its combination of image registration and cloning to produce strobe motion-like videos or pictures without the need of a strobe-equipped camera. Motion tracking or image differencing is utilized herein to locate the region of interest (ROI) in each image. Then one or more of these foreground patches (elements) are extracted to cover the ROI, and pasted into future images (e.g., current image) to properly simulate strobe-motion effects. Elements of the invention utilize image differencing to segment the ROI when the target object is subject to small movement, a task at which the general motion tracking processes fail to perform properly.

The present invention does not require the use of any special equipment, which is often complicated to setup. Using categorization followed by different strobe image processing according to the invention, allows the present method to handle any desired object characteristics and motion in response to receiving a video stream.

The present invention describes methods for generating strobe effects within still image output (pictures) or video output. The techniques can be applied as described herein to generate strobe effects (e.g., still and/or video) in response to conventional 2D video inputs or alternatively in response to 3D video inputs (e.g., having separate stream inputs or a single combined stream).

The teachings of the present invention can be applied to numerous application areas including, providing special strobe functionality within camcorders, digital cameras, image processing applications, computer software, video/image editing software, and combinations thereof.

It will be appreciated that the present invention generates simulated strobe motion video and pictures in a different manner than is found in the industry. First, it should be recognized that the present invention is configured for generating both strobe motion strobe motion video as well as still images. The details of generating strobe motion still images within the present invention differ markedly from what is known in the art. For example, one industry system compares the difference between selected frames to update the segmentation mask.

However, according to the present invention, image registration is applied on the selected images and utilized in combination with a mean-cut process to divide the overlapping area into two parts and then to stitch the two images together.

In the “video” mode, a video classification step is performed first to determine which of two different methods are utilized to generate strobe motion video from a general motion video. A first method is selected in response to determining small target object movements. In this first method, the difference is determined within difference images to locate only the region of interest (which has the larger movement) instead of the whole moving object. This first method generates cleaner and more accurate results for motion video where the object has very small moving distance (e.g., golf swing, pitcher motion in throwing a ball, batter swinging at a ball, and so forth). In a second method selectable by the invention, the moving object (foreground) is separated from the image in response to a generated background model, and then multiple foregrounds are pasted utilizing an object mask on the future background images. It should be appreciated that the above large movement method cannot properly render the strobe motions if the moving distance of the object in the video is very small (relative to the frame) which means general attribute image differencing cannot completely separate the whole object from the background to update segmentation masks.

FIG. 1 illustrates an example embodiment 10 of at least one video mode of the tail the motion method in separating simulated strobe motion into different classifications based on the use of the camera and the characteristics, or motion, of a target object whose image is being captured. Video is input 12 in which at least one target object is in motion. It is determined whether the target object is captured from a static position 14 (non-moving single location), or in response to a moving camera position 16 (e.g., tripod pan/tilt, rolling tripod, jib, dolly, handheld, and so forth) which follows the action. As used herein the phrase “static camera” means that the object remains in the camera viewing range, wherein the camera either does not move, or moves only very slightly, such as due to handheld vibration. The phrase “moving camera” as used herein means the viewing angle of the camera changes in response to a larger change in translation or rotation in order to keep the object, which is subject to larger motions, within its viewing range. In the case of a static camera 14 the object is then classified into being subject to a small amount of motion 18, or a large amount of motion 20, such as in relation to the size of the frame. In the case of a moving camera 16 the object is classified into being a rigid moving object 22 (e.g., car, airplane, ball, and so forth), or a non-rigid object 24 (e.g., person running, playing soccer, ice skating, bird flapping its wings in flight, and so forth). Two general inventive methods are shown in the figure as Method 1 (26), and Method 2 (28), which will be described. In the first method, video processing is limited to the region of interest, while in the second method a background model is created to achieve motion segmentation and to detect the foreground image.

The process according to at least one embodiment of the present invention can be generalized as follows. (a) Applying motion segmentation to detect the foreground object in each image frame. (b) Using the time difference to determine the interval between checkpoint images. (c) Updating overall foreground mask and pasting the overall foreground area on future images when each checkpoint is reached.

2. Small Target Object Movements.

In an implementation of a first method of simulating strobe motion, the object has small motions in relation to the background in the video. By way of example, and not limitation, the threshold for determining whether the motion is considered small, can be determined on the basis of whether the percentage of frame size spanned by the motion, from one frame of video to the next, is below a desired threshold.

As the relative motion is small in this case, in relation to the background, a model of the background is not necessary for applying motion segmentation according to the present invention. Differences between pairs of adjacent source images are determined when finding regions of interest (ROI), and the overall region of interest is updated from a set of one or more standpoints, which are pasted on future source images. The term “standpoint” is used herein to identify a particular state of the target object as it was positioned in a given frame of the input, which is temporally displaced from the current frame of the input. A decaying effect is then preferably achieved in response to using different weights for the ROI from different standpoints.

Step 1: obtaining the binary difference image 1 by taking the difference between an image at time n−2k and an image at time n−k, which is registered to an image at n−2k, such as given by the following.

$${I}_{difference 1} ( x , y ) = \{ \begin{matrix}0 & if \vert {I}_{n - 2 k} ( x , y ) - {I}_{n - k} ( x , y ) \vert \leq threshold \\ 1 & if \vert {I}_{n - 2 k} ( x , y ) - {I}_{n - k} ( x , y ) \vert > threshold\end{matrix}$$

Step 2: obtaining of a binary difference image 2, in response to obtaining the difference between the image at time n−k, registered to the image at time n, and the image at time n, such as follows.

$${I}_{difference 2} ( x , y ) = \{ \begin{matrix}0 & if \vert {I}_{n - k} ( x , y ) - {I}_{n} ( x , y ) \vert \leq threshold \\ 1 & if \vert {I}_{n - k} ( x , y ) - {I}_{n} ( x , y ) \vert > threshold\end{matrix}$$

Step 3: obtaining a foreground mask at time n−2k, by locating the covered background area in the image at time n−2k, in which difference image 2 is registered to difference image 1, such as given by the following.

$${I}_{ROI ( n - 2 k )} ( x , y ) = \{ \begin{matrix}1 & if {I}_{difference 1} ( x , y ) = 1 , or {I}_{difference 2} ( x , y ) = 0 \\ 0 & otherwise\end{matrix}$$

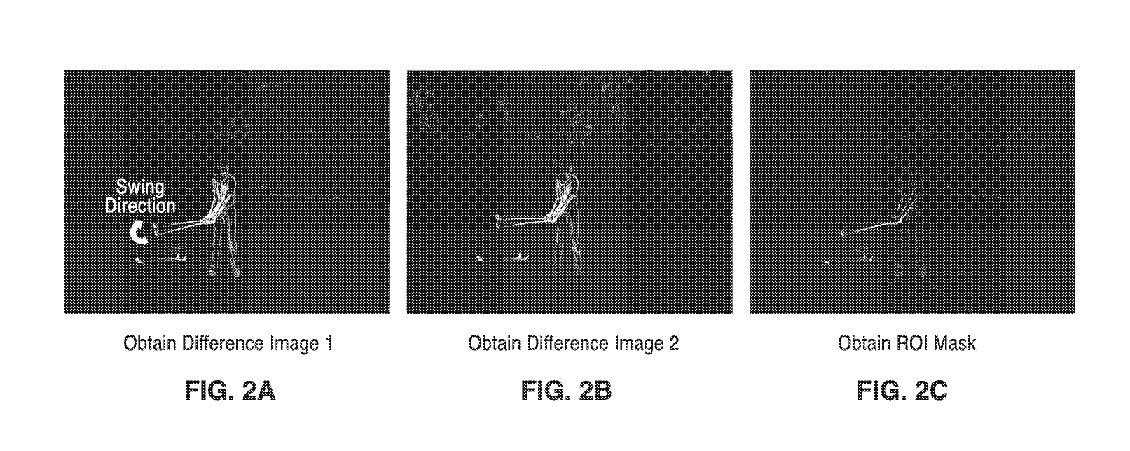

FIG. 2A through FIG. 2C illustrate an example of extracting a foreground mask from a golf video input. In FIG. 2A difference image 1 is shown, while in FIG. 2B difference image 2 is depicted. The region of interest (ROI) mask is determined and is shown in FIG. 2C.

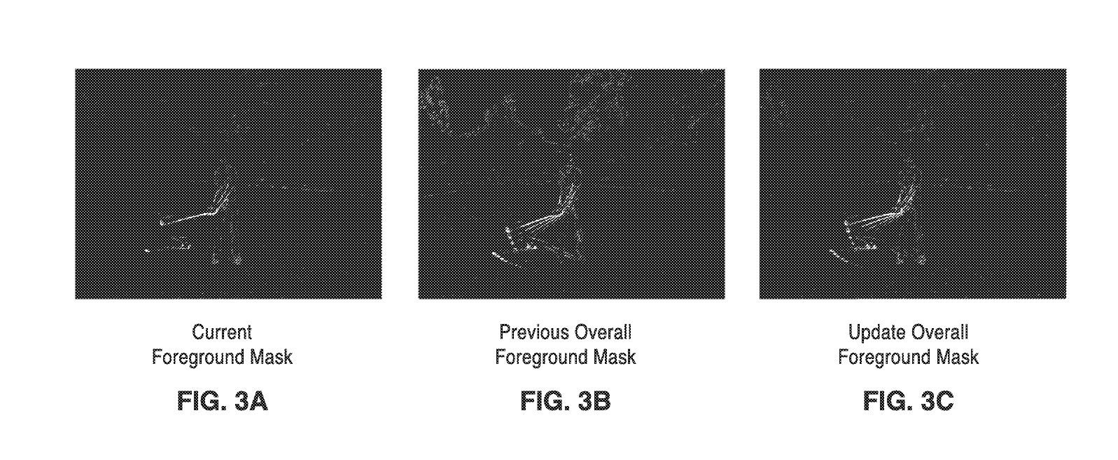

FIG. 3A through FIG. 3C illustrate an example of determining checkpoints and image composition. A checkpoint relationship is determined, such as based on time lengths, target object movement distance, or a combination thereof. This relationship can be predetermined, determined in response to target object motion characteristics, or a combination thereof. The checkpoint relationship is then utilized to determine the selection of each pair of checkpoints. In a time length mode, a first checkpoint may be selected which precedes the current frame by n frames. The foreground mask of the current image is extracted, as seen in FIG. 3A. When each checkpoint is reached, the overall foreground mask is updated, in response to the previous foreground mask (FIG. 3B) being registered and combined with the current foreground mask to form a new overall foreground mask (FIG. 3C). Then the updated foreground region is warped and pasted on the future image frames, with the foreground from the current image being on top.

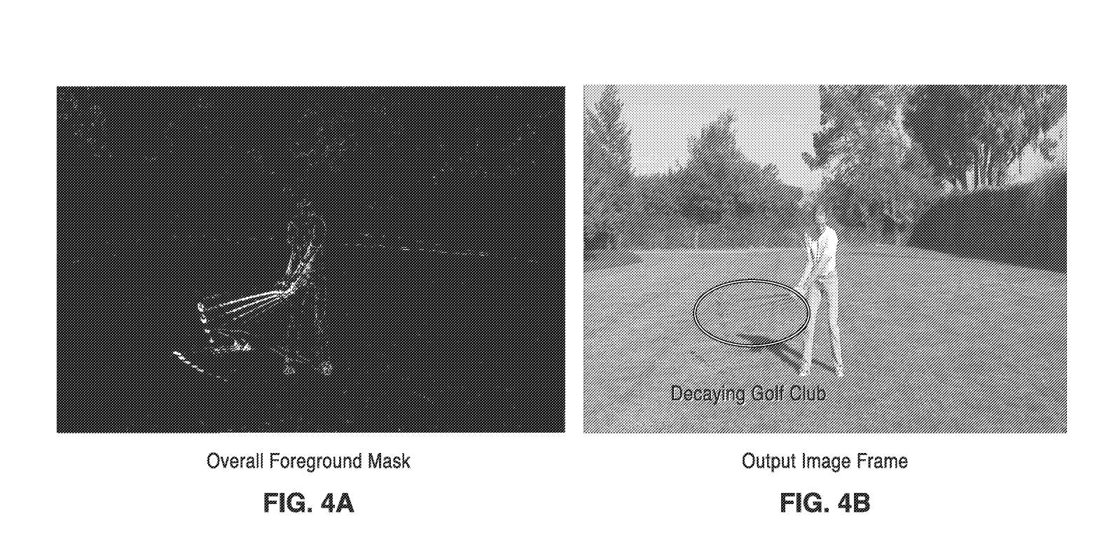

FIG. 4A and FIG. 4B depict an updated overall foreground mask (FIG. 4A) and an output image frame (FIG. 4B) showing image decay in response to applied weighting. When the overall foreground mask is updated, the mask from the previous image frame will be multiplied by a gradually decreasing weight (e.g., smaller than 1.0) to introduce a decaying effect upon that portion of the image.

The value of weight Wₙ₋ₖ for the mask from the previous image Iₙ₋ₖ at time n−k is based on the time difference between the current image frame Iₙ (at time n) and at frame Iₙ₋ₖ:

$${W}_{n - k} = \{ \begin{matrix}( 1 - \frac{1}{N} \times k ) & if ( 1 - \frac{1}{N} \times k ) \geq 0 \\ 0 & if ( 1 - \frac{1}{N} \times k ) < 0\end{matrix}$$

where N is the number of previous decaying objects.

3. Large Target Object Movements.

A second method of generating simulated strobe effects is selected in response to detecting large movements of the target object with respect to the backgrounds. Motion fields are obtained to locate the area of the frame in which larger motions arise. The overall background model is updated and motion segmentation is applied to detect the foreground area. The overall foreground regions are then updated from the standpoints and pasted on future source images.

In response to the detection of large object motions, the present invention generates a background model. The overall background model Iₒᵥₑᵣₐₗₗ_{_{—}}_{bg} is registered (to the current image I_{current}) and then combined with the current image to form an updated overall background model.

After the motion field is obtained in each image, the difference \vec{M}_{difference} the local motion \vec{M}_{local} and the global motion \vec{M}_{global} is computed for each pixel position. A pixel at (x, y) will be assigned to the background if the following two criteria are satisfied:
1.\vec{M}_{difference} is smaller than a threshold (e.g., 0.75).
2. The difference between the pixel value at (x, y) in the current image and in the background image is smaller than a threshold (Luma and Chroma), given by:

|I_{current}(x,y)−Iₒᵥₑᵣₐₗₗ_{_{—}}_{bg}(x,y)|>threshold

The pixel value (Luma and Chroma) in the updated background image is computed, such as by the following:

$${I}_{updated \_ overal l \_ bg} ( x , y ) = \{ \begin{matrix}0.25 \times {I}_{current} ( x , y ) + 0.75 \times {I}_{overall \_ bg} ( x , y ) & if {I}_{current} ( x , y ) ∈ background \\ {I}_{overall \_ bg} ( x , y ) & if {I}_{current} ( x , y ) ∈ foreground\end{matrix}$$

Adaptive thresholding is applied (on Luma and Chroma components) to detect the moving object. The threshold T(x, y) at each pixel position (x, y) is updated in each image according to the following:

T_{current}(x,y)=0.25×|I(x,y)−Iₒᵥₑᵣₐₗₗ_{_{—}}_{bg}(x,y)|²+0.7 5×Tₚᵣₑᵥᵢₒᵤₛ(x,y)

where I(x, y) is the pixel value at position (x, y) in the current image and Iₒᵥₑᵣₐₗₗ_{_{—}}_{bg}(x, Y) is the pixel value at position (x, y) in the background model. A pixel belongs to the moving object if the difference between its pixel value (both Luma and Chroma) and the background model exceeds a desired threshold:

|I(x,y)−Iₒᵥₑᵣₐₗₗ_{_{—}}_{bg}(x,y)≧T_{current}(x,y)

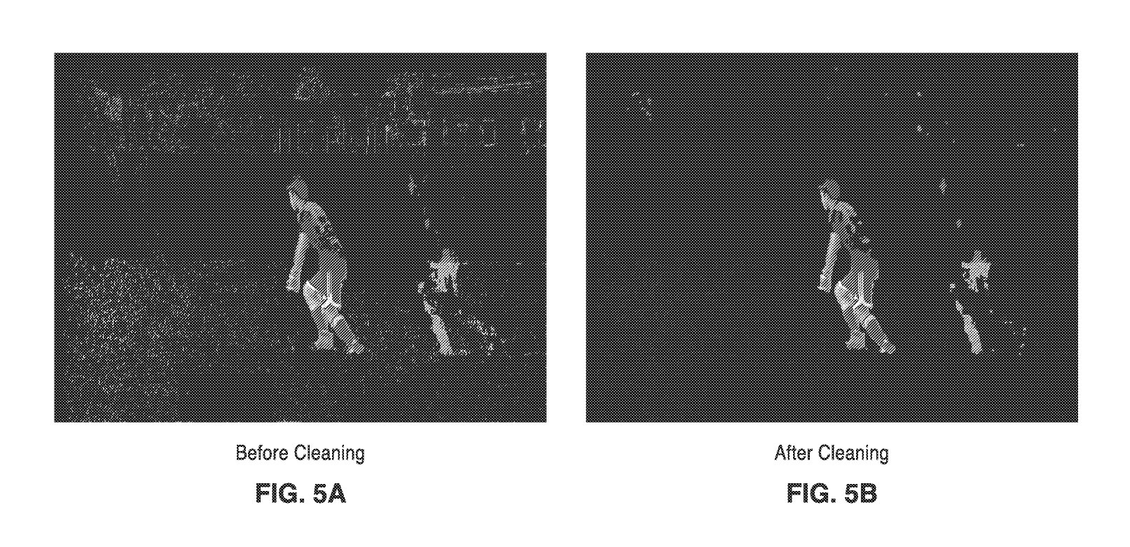

FIG. 5A and FIG. 5B illustrate an example of applying erosion operators followed by dilation operators to clean the foreground image. FIG. 5A depicts foreground selection before cleaning, while FIG. 5B depicts the elements after cleaning has been performed. Dilation operators are applied followed by erosion operators to fill small holes in the foreground image. It should be appreciated that in response to use of a binary mask, erosion completely removes objects smaller than the structuring element and removes perimeter pixels from larger image objects. The dilation operation connects areas that are separated by spaces smaller than the structuring element and adds pixels to the perimeter of each image object.

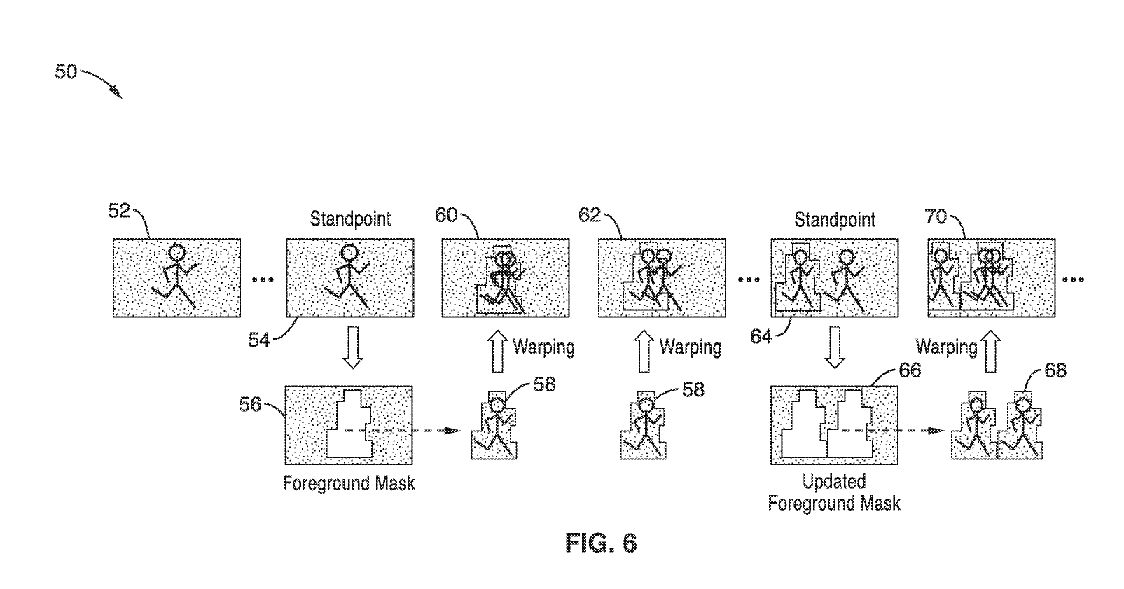

FIG. 6 illustrates an example embodiment 50 of standpoints and image composition according to the invention. The mechanism of selecting standpoints is determined, such as a time length, moving distance, or combination, between each pair of standpoints. An input frame 52 is shown from a video input, with a first standpoint 54 selected. A foreground mask 56 is created of standpoint 54. When each standpoint is reached, the overall foreground mask is updated (the previous foreground mask is registered and combined with the current foreground mask to form a new overall foreground mask. The updated foreground region is warped and pasted on the future image frames (the foreground from the current image is always on top). For example, foreground mask 56 is extracted 58, warped and combined into frame 60, and then into frame 62. In response to a new standpoint 64, the foreground mask 66 is updated, with two standpoints being extracted 68, warped and combined in subsequent frame 70 and so forth until the next standpoint is arrived at. The term “warped”, is used above to refer to geometrically warped according to the camera motion. If the camera motion is specified according to simple translation, this warping corresponds to positionally translated. However, it will be appreciated that camera motion can be specified in more general ways. For example, this warping can include rotation and zoom, or even more general models such as affine or projective transformations can be included separately or in combination with one another.

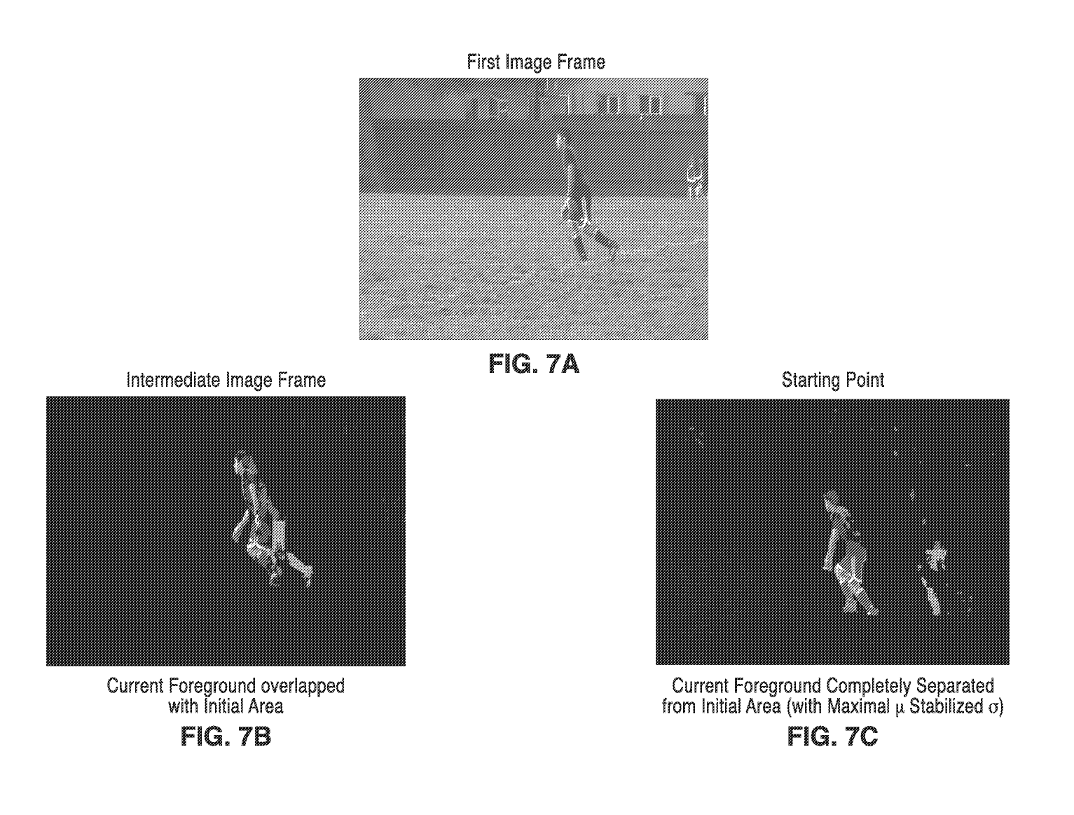

FIG. 7A through FIG. 7C illustrate starting the tail-the-motion method, and shows an original image frame in FIG. 7A. The method is not initialized until the background model is stabilized and the foreground object is completely separated from its initial position (area), which is to say that the target object commences motion. A number of image frames are obtained (e.g., a predetermined number, such as 10, or alternatively a number selected in response to user selection and/or video characteristics) in a sliding window fashion from which a mean value μ and standard deviation value σ from the foreground areas are computed. In one implementation, the starting point is identified as when

$$\frac{σ}{μ} \leq 0.10 ,$$

which indicates that the current foreground object is not overlapped with its initial area, although it will be appreciated that other displacements threshold and means for computing displacements threshold can be utilized without departing from the teachings of the present invention.

In FIG. 7B an intermediate image frame is shown in which the current foreground is overlapping the initial area. In FIG. 7C a starting point is shown in which the current foreground is completely separated from the initial area with maximal μ and stabilized σ.

As motion commences, the present invention selects method 1 as the means of processing the video input. For each source image at time i, the total motion \vec{M}ᵢ of the foreground object is calculated as following:

$${\vec{M}}_{i} = \frac{{\sum }_{( x , y ) ∈ fg} {\vec{M}}_{difference} ( x , y )}{A}$$

where \vec{M}_{difference}(x, y) is the difference between local motion and global motion at pixel position (x, y) and A is the size of foreground object, such as based on the number of pixels. If the accumulated motion from the first image to the first standpoint is greater than 10% of the image height, the program will switch from method 1 to method 2. Otherwise, the program will continue applying method 1. For the sake of simplicity of illustration, the implementation described herein utilizes the same image processing methods for cases 3 and 4 as depicted in FIG. 1, however, it should be appreciated that other processing may be performed as desired according to the present invention when the moving object is non-rigid.

4. Tail the Motion Operating in Picture Mode.

The method can be equally applied to a picture mode, such as according to the following guidelines. Motion segmentation is used for detecting the foreground object in each image frame, wherein the position and area of the foreground objects are located. Distance or time differences are then used to sample source images for making a strobe motion picture. All source images are registered in relation to the reference image. Then each of the source images are stitched together and a cutting path is found between the moving objects to cut the overlapping area.

In performing image cutting the following steps are utilized. It should be appreciated that strobe motion pictures can only be readily produced from video inputs corresponding to cases 2, 3, and 4 (blocks 20, 22, and 24) as depicted in FIG. 1. After the foreground is detected in each image, the centroid of each moving object is calculated and recorded.

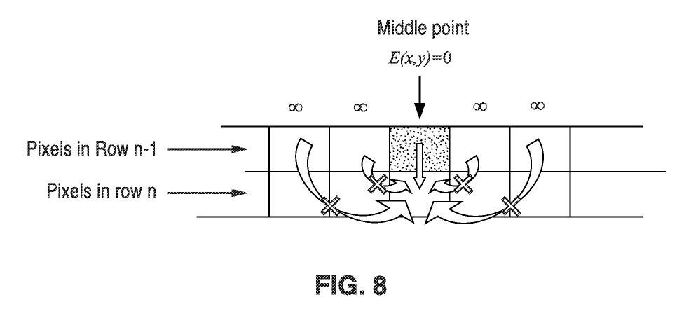

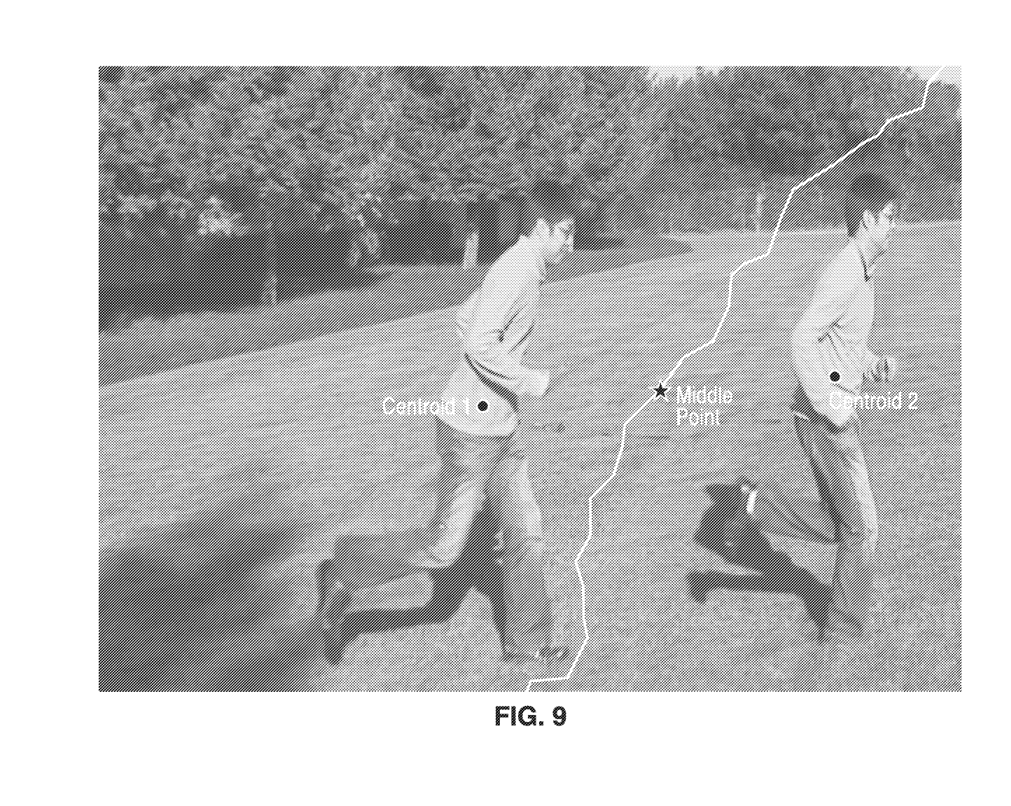

FIG. 8 illustrates a method for dividing the overlapping area for each pair of adjacent images, according to the following steps. (1) Force the cutting line to pass through the middle point of centroids of two moving objects, such as for example setting the cost function at the middle point to 0 and other pixels in the same row/column to infinity. (2) Increasing the cost function within the moving object area, so as to prevent cutting through moving objects.

FIG. 9 illustrates an image cutting example shown in picture mode in joining multiple images to automatically create a simulated strobe motion picture output. The cut line is depicted in white so that the extent of the cutting operation can be readily seen.

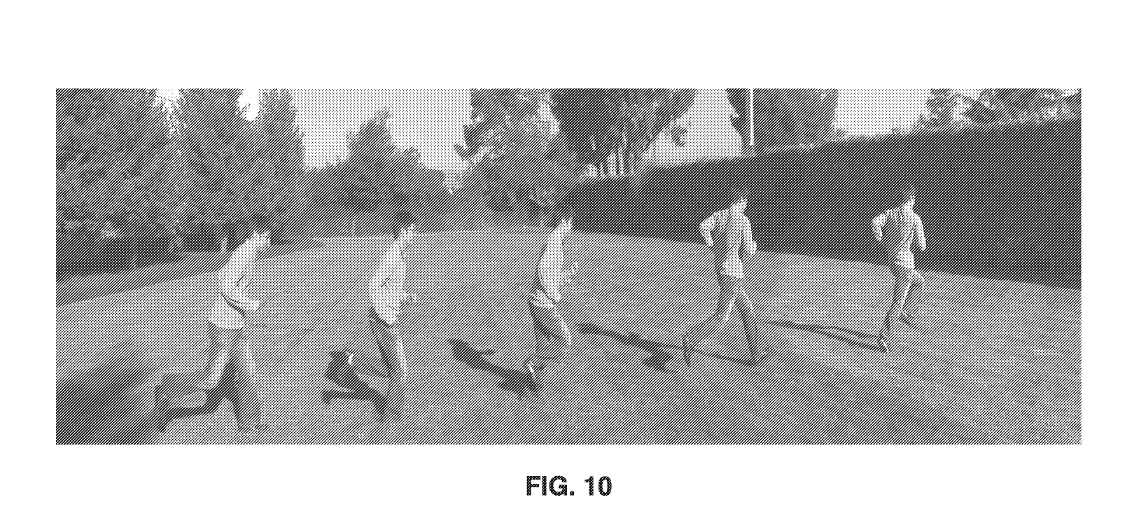

FIG. 10 illustrates an example of stitching together a series of sources images, depicted here from a video of a young man running across a field. It should be appreciated that all source images are registered and stitched together to form a final strobe motion picture.

5. Tail the Motion Operating for 3D Video Inputs.

As previously mentioned, elements of the present invention are applicable to video image data received in many different types and formats, and for generating either video or still image output.

The present invention can be configured, for example, to operate with 3D video inputs to generate strobed stereoscopic output. A 3D input is received and as necessary decoded to divide the two channels. In order to keep the stereoscopic relationship between the strobe effects for the first and second outputs (e.g., right eye video output and left eye video output), the present invention determines how to process a first image and then performs the same processing at the same standpoint on the additional video channel.

Alternatively, as characteristics which work for manipulating an image from a first perspective (e.g., right eye image), may not coincide with that of an image from a second perspective (e.g., the case of finding centroid to base image cutting upon), the present invention provides modes in which information is collected from both images to determine whether to select one or the other image as the pattern, or to average certain characteristics in generating values utilized in driving video processing (e.g., background models, region of interest, checkpoint timing, segmentation, decay), and so forth. It will be appreciated therefore, that the present inventive apparatus and method is fully applicable to both 2D and 3D imaging.

6. Tail the Motion Hardware and Software Summary.

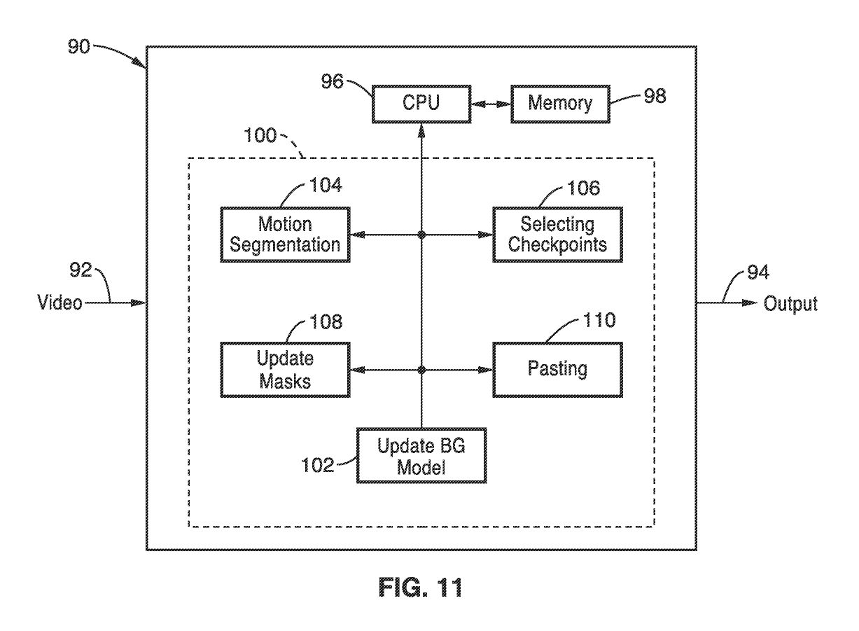

FIG. 11 is an example embodiment 90 of a computer configured for video processing of video 92 according to at least one embodiment of the present invention, and generating an output 94 as video and/or still images containing simulated strobe effects. It should be appreciated that the apparatus 90 can comprise one or more computer processing elements, and one or more memories, each of any desired type to suit the application, used either separately or in combination with any other desired circuitry.

A computer processor 96 is shown with associated memory 98 from which programming is executed for performing strobe effect simulation steps 100, such as including creation and updating 102 of background model, motion segmentation 104, checkpoint selection 106, mask updating 108, and the pasting 110 of foreground material into the destination (e.g., current frame).

It should be appreciated that an apparatus for generating strobe effects according to the present invention can be implemented wholly as programming executing on a computer processor, or less preferably including additional computer processors and/or acceleration hardware, without departing from the teachings of the present invention.

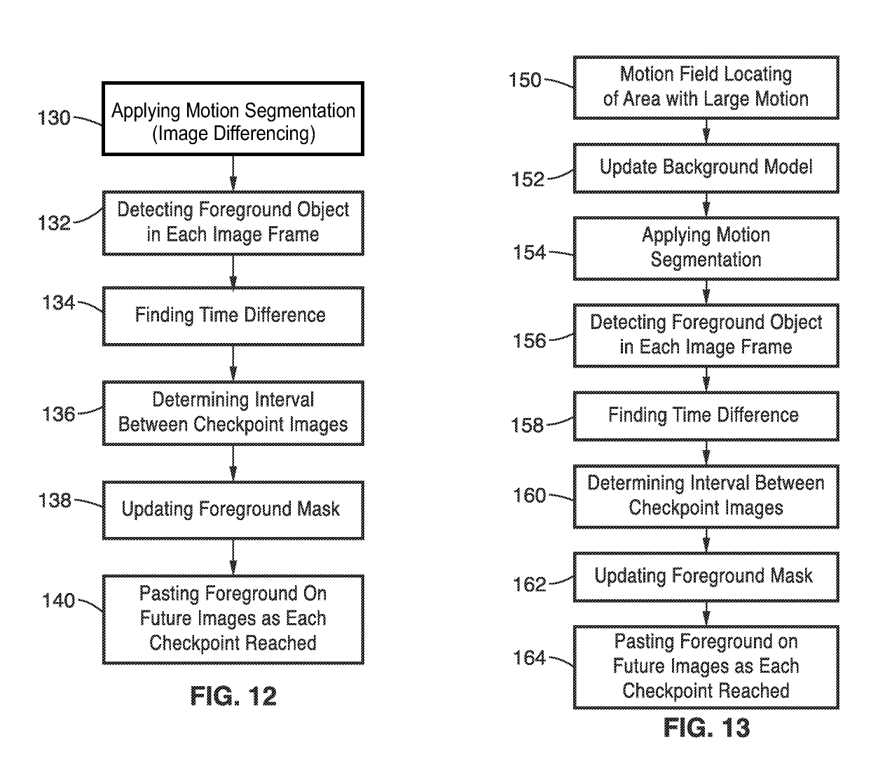

FIG. 12 and FIG. 13 expand on the flowchart of FIG. 1 detailing steps utilized in performing method 1 as seen in FIG. 12 and method 2 as seen in FIG. 13.

In FIG. 12 motion segmentation 130 is applied in response to image differencing, and detecting 132 of the foreground object within the input video sequence. Checkpointing is determined (134-136) which allows a determination as to which target object foregrounds (from which frames of the video) are to be used for representing the strobe motions. It will be appreciated, as previously described that checkpoints can be created in response to time differences, distance of motion, or combinations thereof. These checkpoint determinations can be set in response to predetermined settings, user selected settings, program selected settings in response to the nature or character of the video, or combinations herein. As predetermined time difference is the more typical application, it is described herein by way of example and not limitation. Time difference is found 134 between image from which checkpoint intervals are determined 136. Foreground mask is updated 138, and the foreground strobe contributions from prior checkpoint frames are thus collected. The foreground image data is then pasted 140 into future images, such as the current frame. The above process continues with each new frame and checkpoint.

In FIG. 13 a similar strobe generation is seen which is applicable to large target object motion. The location of the large motion field is determined 150, and updating (or creation) of the background model 152 is performed. Then motion segmentation 154 is performed, and the foreground object within the input video sequence is detected 156. Checkpointing is determined in response to finding 158 the time difference, from which checkpoint intervals are determined 160. The foreground mask is updated 162, and the foreground strobe contributions from prior checkpoint frames are thus collected. The foreground image data is then pasted 164 into future images, such as the current frame. The above process continues with each new frame and checkpoint.

This section summarizes, by way of example and not limitation, a number of implementations, modes and features described herein for the present invention. The present invention provides methods and apparatus for generating strobe image output, and includes the following inventive embodiments among others:

1. An apparatus for generating simulated strobe effects, comprising:

a computer configured for receiving video having a plurality of frames; a memory coupled to said computer; and programming executable on said computer for, receiving a video input of a target object in motion within a received video sequence, determining whether the camera is capturing target object motion within the received video sequence in response to a static positioning or in response to a non-static positioning, selecting a strobe effect generation process, from multiple strobe effect generation processes, in response to determining said static positioning or said non-static positioning, and generating a simulated strobe effect output in which one or more foreground elements are extracted from prior video frames and combined into a current frame in response to registering and cloning of images within the video input.

2. The apparatus of embodiment 1, wherein said programming executable on said computer for generating a simulated strobe effect output comprises: applying motion segmentation to detect a foreground object in each image frame of the received video sequence; selecting at least one checkpoint image based on time differences of each image frame within the received video sequence to attain a desired interval between checkpoint images; and updating an overall foreground mask and pasting an overall foreground area on future images as each said checkpoint image is reached.

3. The apparatus of embodiment 2, further comprising programming executable on said computer for generating a background model for applying said motion segmentation if the relative motion of the target object is large in relation to the frame size.

4. The apparatus of embodiment 1, further comprising programming executable on said computer for selecting between motion tracking for large motions or image differencing for small motion when determining a region of interest (ROI) within the received video sequence.

5. The apparatus of embodiment 1, further comprising programming executable on said computer for determining image differenced as a basis of segmenting the region of interest within the received video sequence.

6. The apparatus of embodiment 1, wherein said multiple strobe effect generation process comprises a first process and a second process within programming executable on said computer; wherein said first process is selected in response to detection of commencement of target object motion; wherein if a large motion is detected in response to accumulated motion exceeding a threshold, then a switch is made within programming executable on said computer from said first process to said second process; and wherein if no large motion is detected, then generation of simulated strobe effect output continues according to said first method for small motion.

7. The apparatus of embodiment 1, wherein said simulated strobe motion output contains multiple foreground images of a target object, representing different time periods along a trajectory captured in the received video sequence, over a single background image.

8. The apparatus of embodiment 1, wherein said apparatus is selected from the group of devices configured for processing received video sequences consisting of camcorders, digital cameras, video recorders, image processing applications, televisions, display systems, computer software, video/image editing software, and/or combinations thereof.

9. The apparatus of embodiment 1, wherein said simulated strobe effect output comprises a video.

10. The apparatus of embodiment 1, wherein said simulated strobe effect output comprises a still image.

11. The apparatus of embodiment 1, wherein said simulated strobe effect output is a still image, generated in response to programming executable on said computer, comprising: dividing an image area which overlaps between each pair of adjacent images in response to; forcing a cutting line to pass through a middle point of centroids of an identified moving object in each pair of adjacent images using a cost function, and increasing the cost function within the image area of the identified moving object to prevent cutting through the identified moving object.

12. An apparatus for generating simulated strobe effects, comprising: a computer configured for receiving a video input having a plurality of frames; memory coupled to said computer; and programming executable on said computer for; receiving the video input of a target object in motion within a received video sequence; determining whether the received video sequence is capturing small or large target object motion; generating or updating a background model in response to detection of large target object motion; applying motion segmentation; selecting checkpoint images, and generating a simulated strobe effect output in which one or more foreground elements are extracted from prior video frames and combined into a current frame in response to registering and cloning of images within the video input.

13. The apparatus of embodiment 12, further comprising programming executable on said computer for determining image difference as a basis for segmenting a region of interest within the video sequence

14. The apparatus of embodiment 12, wherein said simulated strobe motion output contains multiple foreground images of the target object, representing different time periods along a trajectory captured in the received video sequence, over a single background image.

15. The apparatus of embodiment 12, wherein said apparatus is selected from a group of devices configured for processing received video consisting of camcorders, digital cameras, video recorders, image processing applications, televisions, display systems, computer software, video/image editing software, and/or combinations thereof.

16. The apparatus of embodiment 12, wherein said simulated strobe effect output comprises a video.

17. The apparatus of embodiment 12, wherein said simulated strobe effect output comprises a still image.

18. The apparatus of embodiment 12, wherein said simulated strobe effect output is a still image, generated in response to programming executable on said computer, comprising: dividing an overlapping area between each pair of adjacent images in response to: forcing a cutting line to pass through a middle point of centroids of the target object, as represented in the adjacent images, using a cost function, and increasing said cost function within the overlapping area, between the pair of adjacent images, to prevent cutting through representations of the target object in either of the pair of adjacent images.

19. A method of generating simulated strobe effects, comprising:

receiving video input of a target object in motion within a received video sequence; determining whether the received video sequence depicts capturing target object motion within the received video sequence in response to a static positioning or in response to a non-static positioning; selecting a strobe effect generation method, from multiple strobe effect generation methods, in response to determining said static positioning or said non-static positioning; and generating a simulated strobe effect output in which one or more foreground elements are extracted from prior video frames and combined into a current frame in response to registering and cloning of images within the video input.

20. The method of embodiment 19, wherein said simulated strobe effect output comprises a video or a still image.

Embodiments of the present invention are described with reference to flowchart illustrations of methods and systems according to embodiments of the invention. It will be appreciated that elements of any “embodiment” recited in the singular, are applicable according to the inventive teachings to all inventive embodiments, whether recited explicitly, or which are inherent in view of the inventive teachings herein. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for generating simulated strobe effects, comprising:
(a) a computer configured for receiving video having a plurality of frames;
(b) a memory coupled to said computer; and
(c) programming executable on said computer for,
receiving a video input of a target object in motion within a received video sequence,
determining whether the camera is capturing target object motion within the received video sequence in response to a static positioning or in response to a non-static positioning,
selecting a strobe effect generation process, from multiple strobe effect generation processes, in response to determining said static positioning or said non-static positioning, and
generating a simulated strobe effect output in which one or more foreground elements are extracted from prior video frames and combined into a current frame in response to registering and cloning of images within the video input.

2. The apparatus recited in claim 1, wherein said programming executable on said computer for generating a simulated strobe effect output is configured for:
applying motion segmentation to detect a foreground object in each image frame of the received video sequence;
selecting at least one checkpoint image based on time differences of each image frame within the received video sequence to attain a desired interval between checkpoint images; and
updating an overall foreground mask and pasting an overall foreground area on future images as each said checkpoint image is reached.

3. The apparatus recited in claim 2, further comprising programming executable on said computer for generating a background model for applying said motion segmentation if the relative motion of the target object is large in relation to the frame size.

4. The apparatus recited in claim 1, further comprising programming executable on said computer for selecting between motion tracking for large motions or image differencing for small motion when determining a region of interest (ROI) within the received video sequence.

5. The apparatus recited in claim 1, further comprising programming executable on said computer for determining image differences as a basis of segmenting the region of interest within the received video sequence.

6. The apparatus recited in claim 1:
wherein said multiple strobe effect generation process comprises a first process and a second process within programming executable on said computer;
wherein said first process is selected in response to detection of commencement of target object motion;
wherein if a large motion is detected in response to accumulated motion exceeding a threshold, then a switch is made within programming executable on said computer from said first process to said second process; and
wherein if no large motion is detected, then generation of simulated strobe effect output continues according to said first method for small motion.

7. The apparatus recited in claim 1, wherein said simulated strobe motion output contains multiple foreground images of a target object, representing different time periods along a trajectory captured in the received video sequence, over a single background image.

8. The apparatus recited in claim 1, wherein said apparatus is selected from the group of devices configured for processing received video sequences consisting of camcorders, digital cameras, video recorders, image processing applications, televisions, display systems, computer software, video/image editing software, and/or combinations thereof.

9. The apparatus recited in claim 1, wherein said simulated strobe effect output comprises a video.

10. The apparatus recited in claim 1, wherein said simulated strobe effect output comprises a still image.

11. The apparatus recited in claim 1, wherein said simulated strobe effect output is a still image, generated in response to programming executable on said computer configured for,
dividing an image area which overlaps between each pair of adjacent images in response to,
forcing a cutting line to pass through a middle point of centroids of an identified moving object in each pair of adjacent images using a cost function, and
increasing the cost function within the image area of the identified moving object to prevent cutting through the identified moving object.

12. An apparatus for generating simulated strobe effects, comprising:
(a) a computer configured for receiving a video input having a plurality of frames;
(b) a memory coupled to said computer; and
(c) programming executable on said computer for,
receiving the video input of a target object in motion within a received video sequence,
determining whether the received video sequence is capturing small or large target object motion,
generating or updating a background model in response to detection of large target object motion,
applying motion segmentation,
selecting checkpoint images, and
generating a simulated strobe effect output in which one or more foreground elements are extracted from prior video frames and combined into a current frame in response to registering and cloning of images within the video input.

13. The apparatus recited in claim 12, further comprising programming executable on said computer for determining image difference as a basis for segmenting a region of interest within the video sequence.

14. The apparatus recited in claim 12, wherein said simulated strobe motion output contains multiple foreground images of the target object, representing different time periods along a trajectory captured in the received video sequence, over a single background image.

15. The apparatus recited in claim 12, wherein said apparatus is selected from a group of devices configured for processing received video consisting of camcorders, digital cameras, video recorders, image processing applications, televisions, display systems, computer software, video/image editing software, and/or combinations thereof.

16. The apparatus recited in claim 12, wherein said simulated strobe effect output comprises a video.

17. The apparatus recited in claim 12, wherein said simulated strobe effect output comprises a still image.

18. The apparatus recited in claim 12, wherein said simulated strobe effect output is a still image, generated in response to programming executable on said computer for,
dividing an overlapping area between each pair of adjacent images in response to,
forcing a cutting line to pass through a middle point of centroids of the target object, as represented in the adjacent images, using a cost function, and
increasing said cost function within the overlapping area, between the pair of adjacent images, to prevent cutting through representations of the target object in either of the pair of adjacent images.

19. A method of generating simulated strobe effects, comprising:
(a) receiving video input of a target object in motion within a received video sequence;
(b) determining whether the received video sequence depicts capturing target object motion within the received video sequence in response to a static positioning or in response to a non-static positioning;
(c) selecting a strobe effect generation method, from multiple strobe effect generation methods, in response to determining said static positioning or said non-static positioning; and
(d) generating a simulated strobe effect output in which one or more foreground elements are extracted from prior video frames and combined into a current frame in response to registering and cloning of images within the video input.

20. The method recited in claim 19, wherein said simulated strobe effect output comprises a video or a still image.
